(19) United States
(12) Patent Application Publication
(10) Pub. No.: US 2003/0001398 A1
(43) Pub. Date: Jan. 2, 2003

(54) Trunk buddy

(76) Inventor: Ralph Erich Koeniger, Lacombe, LA (US)

Correspondence Address: RALPH E. KOENIGER, 26389 CLOVERLAND RD., LACOMBE, LA, 70445, US

(21) Appl. No.: 09/883,311

(22) Filed: Jun. 19, 2001

(51) Int. Cl. E05C 19/18

(52) U.S. Cl. 292/288

(57) ABSTRACT

The TRUNK BUDDY is used to hold an automobile trunk lid, hatch back or lift-gate, so that it will not move while transporting oversized objects in a trunk or cargo area that can not be normally closed because of the oversized object(s) being transported. The TRUNK BUDDY is an extension of the automobile manufacturers trunk lid, hatch back or lift-gate latching mechanisms to allow for the safe transportation of oversized objects in an automobile trunk or cargo area. There are two versions of the TRUNK BUDDY that share the exact same RING and SPRING-LOADED HOOK mechanisms which are very similar to the automobile manufacturer's trunk lid lock and trunk lid striker. One is the TRUNK BUDDY STRAP version which holds the trunk lid against the LOAD being transported. The other version is the TRUNK BUDDY POLE version which holds the trunk lid off of the LOAD being transported in order to protect both the load and trunk lid from being damaged.

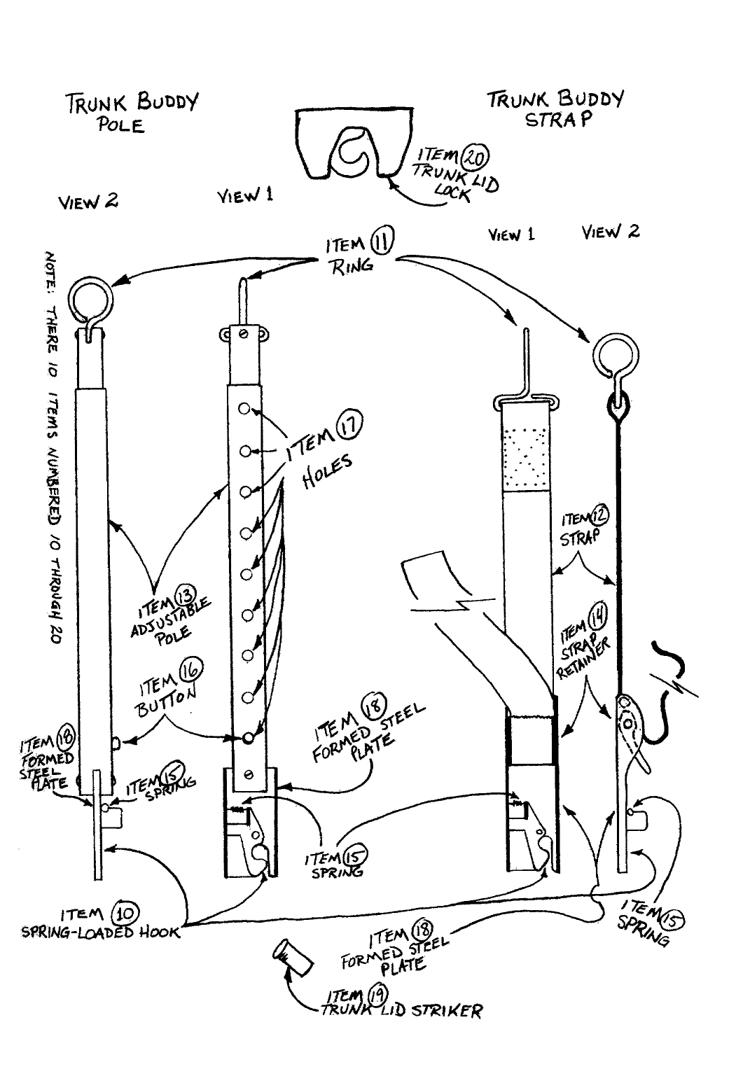

### REFERENCE TO A MICROFICHE APPENDIX

N/A

### STATEMENT REGARDING FEDERALLY SPONSORED RESEARCH OR DEVELOPMENT

N/A

### BACKGROUND OF INVENTION

This invention, the Trunk Buddy, relates to a trunk lid fastening/holding device for any automobile with a trunk lid, liftgate or tailgate for the purpose of keeping the lid from moving while transporting an oversized load that would keep the trunk lid from closing completely. This device can be safely installed, adjusted and released in a matter of seconds, requiring no permanent attachment to the vehicle. It uses the existing automobile manufacturer's lock and striker. There are two versions of the Trunk Buddy, the strap version and the pole version. Both device utilize the exact same attachment means. The strap version holds the lid onto the load being transported and the pole version holds the lid off of the load.

It is common for people to carry oversized loads in an automobile trunk or cargo compartment in the case of sport utility vehicles. Typically the lid is held in place or not, by means of string, a length of wire or elastic cords. Feeding the string or wire through holds in the sheet metal of a trunk lid is time consuming and somewhat dangerous because of the possibility of being cut. Most of the time the string or wire will come loose with the first bounce of the load during transport. In the case of elastic straps which are hooked into place, if there are suitable attaching points, the elastic straps are usually too long or short. This creates a dangerous situation because the elastic straps could lash back at the person trying to install them.

Some typical applications for the strap version is when carrying luggage, a box or some other load where it would not matter if the lid rested on the load. The trunk lid would be pulled onto the load therefore securing the lid. Some typical applications for the pole version is when carrying a lawnmower, bicycle or plant in the trunk. In those cases the lid would be held off of the load keeping both the load and trunk lid from being damaged. The pole version would be installed and the appropriate height adjustment made to secure the lid in a fixed position.

Patented devices that are similar to the strap version of the Trunk Buddy are DeLisio in U.S. Pat. No. 5,647,619; Charman in U.S. Pat. No. 4,666,194; Barner in U.S. Pat. No. 4,191,413; Elrod in U.S. Pat. No. 3,971,589; Popp in U.S. Pat. No. 5,320,398; Wamsley in U.S. Pat. No. 2,916,902. All have adjustable straps as a means of holding the lid onto the load being carried. However, all but DeLisio and Charman require permanent attachment to the vehicle.

DeLisio utilizes a large hook at one end of the strap and a large triangular ring at the other for attachment means. These large attachment means will not fit many of the relatively small areas where the automobile locks and strikers are located. The strap length adjustment is at the triangular ring end of the strap along with two other circular friction cinch rings. Length adjustment would be difficult because the three rings are in such close proximity as well having to pull simultaneously on two straps. In order to get the straps to move there should be no tension on the two circular cinch rings. The length adjustment process would require multiple manipulations to achieve the proper length. Furthermore, this method of cinching the straps could easily come loose with the first bounce of the load because when tension is released, the two rings simply fall open.

Charman utilizes a triangular keeper at one end of the strap that must be rotated to fit a given size lock mechanism. This will require several manipulations of the triangular keeper. This design may not fit the relatively small areas where the trunk lid lock is located. The opposite end of the strap shows a openable clasp as a means for attachment to the striker of the trunk. Attaching the clasp could be fairly easy providing there is enough room to push the clap sideways while in the hole where the striker is located.

Charman continued:

However, removing the clasp would definitely prove to be a challenge. Due to fact one must utilize both a finger and thumb to squeeze the clasp and then with the finger, squeezed clasp and thumb, move sideways and downward to get the clasp off of the striker. Most trunk lid strikers are in a hold which would make the release of this design an extremely difficult task. Furthermore the strap length adjustment is similar to that of DeLisio in that there should be no tension on the strap in order to adjust the length. The Charman length adjustment design is not as good as DeLisio because with the first Bounce of the load the strap would become loose.

Patented devices similar to the pole version of the Trunk Buddy are Lach in U.S. Pat. No. 4,634,170; Zimmerman in U.S. Pat. No. 5,228,737; Adleberg in U.S. Pat. No. 4,124,240; Conte in U.S. Pat. No. 5,163,724; Taylor in U.S. Pat. No. 4,062,583; Shelton in U.S. Pat. No. 4,925,230; Tomaszewski-Link in U.S. Pat. No. 5,516,168; Barrowman in U.S. Pat. No. 4,307,907; Stegall in U.S. Pat. No. 2,434,598; Rashbaum in U.S. Pat. No. 4,278,280; Glock in U.S. Pat. No. 4,070,050.

Lach requires very specific attaching points for hatchbacks only. Zimmerman, Adleberg & Conte utilize various clamping devices at both ends of the devices making for a tedious installation, adjustment and removal, with the possibility of damaging the areas of attachment. Taylor, Shelton and Tomaszewski-Link require permanent attachment to the vehicle. Barrowman utilizes a large mechanical folding arm and this design is primarily used to hold the trunk lid for spray paint application in the automobile manufacturing industry. Stegall utilizes U-shaped brackets at each end for propping open an automobile hood. Glock and Rashbaum are very similar to each other in that they are complicated devices requiring awkward and many manipulations to install. Both require screwing a hand-wheel nut to tighten against the trunk striker, providing there is enough room to fit the bulky mechanism(s). Rashbaum utilizes an attachment means to a trunk striker that is no longer in use. This design is outdated and will only fit very old vehicles. Both devices articulate to compensate for the angle of an open trunk lid. The opposite end of each device is pushed into the trunk lid lock, but because of the bulky design both would be limited as to the type of vehicles they could fit.

### BRIEF SUMMARY OF THE INVENTION

What makes the Trunk Buddy strap and pole versions totally unique is the manner in which they are attached to the vehicle. Both the pole version and strap version have the exact same ring and spring-loaded hook attaching means. Each end is simply pushed onto the existing automobile trunk lid lock and trunk lid striker. The Trunk Buddy requires no permanent attachment and no mechanical manipulations during installation, length adjustment or removal. All of which can be done in under five seconds. All other designs require either permanent attachment, multiple mechanical manipulations, screw-tightening or awkward length adjustments to install.

Length adjustment of an installed Trunk Buddy strap is done by pulling the strap therefore lowering the lid onto the load. Since the strap retainer is a cam design, upward motion locks the strap even tighter. The Trunk Buddy pole version height is adjusted by pushing a spring-loaded button, stretching or collapsing the telescopic pole to the desired height and then allowing the positive locking button to pop into the appropriate hole. The attach it to the trunk lid lock and trunk lid striker the exact same way as the strap version. In both cases the trunk lid will stay in that position until it is released. Because the ring and spring-loaded hook ends very closely match the automobile manufacturer's design, the fit of the Trunk Buddy devices are virtually the same as if the trunk lid were actually closed.

### BRIEF DESCRIPTION OF THE SEVERAL VIEWS OF THE DRAWING

The item numbers listed below describe each part of the strap and pole versions of the Trunk Buddy. There are 10 items starting with the number 10 and finishing with the number 20.

Item 10: Hook

The hook is stamped and formed steel with a pointed end that has a ½ inch diameter half circle, that attaches to the trunk lid striker. The hook is spring-loaded in the closed position and is released via a trigger at the opposite end of the pointed side.

Item 11: Ring

The ring is made from ⅛^{th} inch diameter wire or rod stock. It is formed into a 1½ inch diameter ring and permanently attached to a one inch wide, six foot long nylon strap. Also attached to one end of the pole version.

Item 12: Strap

The strap is made of standard nylon, one inch wide and is six foot long. The ring is permanently attached at one end while the other end is fed through the strap retainer which is also where the spring-loaded hook is located.

Item 13: Adjustable Pole

The pole is made up of two sections, one fits inside the other and each are approximately two feet long allowing for telescopic action. The outer pole has holes in one side where a spring-loaded button protrudes through. The button is attached to the inside pole and this is the means for adjusting the height. One end of the pole has the ring attached while the other end has the spring-loaded hook attached.

Item 14: Strap Retainer

The strap retainer is a spring-loaded cam clip that presses against the nylon strap to hold it securely in place. Pressing the retainer releases the pressure on the strap allowing the length adjustment.

Item 15: Hook Spring

This spring keeps the hook in a closed position.

Item 16: Button

This spring-loaded button is pushed in order to adjust the pole height telescopically.

Item 17: Holes

These are the holes where the spring-loaded button rests to lock the height of the pole.

Item 18: Formed Steel Plate

This plate is where the spring-loaded hook is located. For the strap version, the strap retainer is mounted to this plate as well.

Item 19: Trunk Lid Striker

Trunk lid strikers vary in size from ⅛^{th} inch to ½ inch in diameter depending on the make and model of automobile.

Item 20: Trunk Lid Lock

Trunk lid locks vary in size in relation to the trunk lid striker.

### DETAILED DESCRIPTION OF THE INVENTION

The Trunk Buddy strap version and pole version utilize the same attachment means to hold a trunk lid, lift-gate so it will not move during transportation of oversized objects. The most important factors are the means of attachment which are unique to the Trunk Buddy. These attachment means are what allow the Trunk Buddy to be installed, adjusted and released in a matter of seconds. All other lid holding devices require either permanent attachment which could take hours to install or require the devices to be articulated in such a manner to fit properly or require tightening of threaded nuts, wing nuts and/or thumb screws or require cumbersome and difficult manipulations to adjust the height properly. In the best case scenario of other lid holding devices, it would take a few minutes to install, not mere seconds as with the Trunk Buddy. The Trunk Buddy attachment means very closely resemble the automobile manufacturer's design (See items 19 & 20). Thus making the Trunk Buddy fit homogeneous and universal to all makes and models of automobiles whereas the other designs are not similar and will not fit universally.

The ring, item 11, is made of ⅛^{th} inch diameter steel wire or rod stock, formed into a 1½ inch diameter circle at one end and an elongated oval opening 1 inch wide by ¼ inch tall at the other end. The ring material size of ⅛^{th} inch diameter rod stock was chosen because the smallest trunk lid striker was found to be ⅛^{th} of an inch in diameter and the largest striker was found to be ½ inch in diameter. This ring, item 11, was tested in various junk yards with virtually every make and model automobile, foreign and domestic. The 1½ inch diameter ring size accommodates the trunk lid lock at any angle from the trunk lid virtually closed to wide open. The other patented devices require tedious articulation to fit the angle of the trunk lid properly. The ring is pushed into the trunk lid lock and can not be released or come loose unless the key that opens the trunk is used or the remote trunk release inside the auto is used.

The spring-loaded hook, combined item numbers 10, 15 & 18, was tested in the same fashion as the ring, item 11. The spring-loaded hook fits all makes and models as mentioned above. Unlike the other patented devices, the Trunk Buddy spring-loaded hook installs onto the trunk lid striker in less than one second. It is pushed onto the trunk lid striker and can not come loose or release unless the trigger on the top of the hook is used to push back the hook therefore releasing the trunk lid striker then allowing the entire mechanism to be lifted straight out. With the spring-loaded hook installed, the trigger release is situated above the trunk lid body, for easy release without the need of reaching into the trunk lid striker hole.

The Trunk Buddy strap version, combination of items 10, 11, 12, 14 & 15, has the ring, item 11, permanently attached to the one inch wide, six foot long nylon strap. The other end of the strap is fed through the strap retainer, item 14. Once the ring is installed into the trunk lid latch, item 20 and spring-loaded hook, combination of items 10, 14, 15 & 18, is installed onto the trunk lid striker, item 19, pull the loose end of the strap so that the trunk lid lowers and rests on the load. There is no need to press the strap retainer, item 14, to loosen the strap to bring the lid into contact with the load. It automatically is loosened when the loose end of the strap is pulled. However, since it is a cam retainer, the harder the upward motion of the trunk lid, the tighter the strap retainer holds the strap. Even with downward motion from the trunk lid, the strap still can not come loose due to the stiff spring holding the strap retainer against the strap. The Trunk Buddy strap is released in a fraction of a second via the trunk key or remote trunk release and/or by pressing the trigger on the spring-loaded hook combined items 10, 14, 15 & 18, end of the strap. None of the other patented designs can be installed, adjusted or released as quickly.

The Trunk Buddy pole version, combination of items 10, 11, 13, 15, 16, 17 & 18, has the same ring, item 11, design permanently attached to one side of the pole while the spring-loaded hook, combination of items 10, 15 & 18, is permanently attached to the other side. The only difference is that there is no strap retainer, item 14, because the height is adjusted via the button, item 16, and the holes, item 17. To adjust the height push the button, item 16, and with a telescopic motion of the pole, raise or lower the lid to the desired height until the button clicks into the appropriate hole, item 17. Pushing the ring, item 11, into the trunk lid lock, item 20, and pushing the opposite end with the spring-loaded hook, combination of items 10, 15 & 18, onto the trunk lid striker, item 19, is all it takes to install the Trunk Buddy pole. This can be accomplished in three seconds. Again, no articulation of the pole is required because of the 1½ inch diameter ring which can accommodate the trunk lid lock at any angle from virtually closed to fully open. None of the other patented devices can accomplish this without having to articulate portions of the pole and/or manipulate the device to fit and/or screw down the locking mechanism. The Trunk Buddy pole is released in a fraction of a second via the trunk key or remote trunk release and/or by pressing the trigger on the spring-loaded hook, combined items 10, 15 & 18, end of the pole. All other patented devices would require loosening of threaded nuts, wing nuts and/or thumb screws or require cumbersome and difficult manipulations to remove the devices.

1. I claim that no other similar device can be attached, adjusted and then released in a matter of seconds as with the Trunk Buddy in either the strap or pole version.

2. I claim universal fit to virtually all makes and models of automobiles, foreign and domestic in either the strap or pole version of the Trunk Buddy.

3. I claim that the Trunk Buddy in either the strap or pole version requires no articulation to accommodate the trunk lid lock or trunk lid striker at various angles.
